(19) United States
(12) Patent Application Publication
(10) Pub. No.: US 2006/0116482 A1
(43) Pub. Date: Jun. 1, 2006

(54) Binder mixtures containing bicyclo orthoester (BOE) and/or polyorthoester groups

(75) Inventors: Holger Mundstock, Wermelskirchen (DE); Meike Niesten, Köln (DE); Jörg Schmitz, Köln (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/287,546

(22) Filed: Nov. 23, 2005

(30) Foreign Application Priority Data
Nov. 26, 2004 (DE) 102004057224.0

(51) Int. Cl. C08F 291/00

(52) U.S. Cl. 525/266

(57) ABSTRACT

The present invention relates to binder compositions containing sulphonate-functional polyisocyanates and one or more polyorthoester and/or bicyclo orthoester groups which are either chemically incorporated into the sulphonate-functional polyisocyanates or present in admixture with the sulphonate-functional polyisocyanates. The present invention also relates to a process for preparing these binder compositions from either OH functional polyorthoesters or from bicyclo orthoesters, and to coating, adhesive and sealant compositions containing the binder compositions of the invention.

### BACKGROUND OF THE INVENTION

1. Field of the Invention

The present invention relates to new binder mixtures based on sulphonate-modified polyisocyanates and on compounds containing bicyclo orthoester (BOE) and/or polyorthoester groups.

2. Description of Related Art

The use of compounds containing polyorthoester and/or bicyclo orthoester groups as latent polyols is known in polyurethane chemistry and described, for example, in EP-A 0 882 106, EP-A 1 225 172 and unpublished application DE 10 200 400 34 95. They describe systems in which NCO and polyorthoester and/or bicyclo orthoester groups are used in one molecule (one-component [1 K] systems) or in separate components (two-component [2 K] systems).

Under the influence of atmospheric moisture the polyorthoester and/or bicyclo orthoester groups undergo deblocking through hydrolytic cleavage, releasing hydroxyl groups, which subsequently react with the NCO groups, a reaction accompanied by crosslinking. In order to maximize the cure rate of such systems, acid catalysts, which accelerate the deblocking, are typically added.

The coatings obtained from these systems are distinguished by rapid drying, high hardness and good chemical resistance, and thus are highly suited to automotive refinish. A disadvantage, however, is that these formulations, due to the presence of the acid catalyst, are relatively sensitive towards moisture and possess only a limited capacity for storage. Also, these coating systems have only a restricted application reliability, which is manifested, according to ambient conditions (relative humidity, temperature), by blistering and/or clouding of the cured films.

Although a separate formulation, excluding the acid catalyst, does improve the stability, it entails increased cost and inconvenience due to the increased cost and inconvenience involved in producing the ready-to-apply coating compositions.

It is therefore an object of the present invention to optimize the systems described above such that it is no longer necessary to add the acid catalyst separately and without any loss in storage stability. The systems can be formulated into coating compositions combining rapid cure with good chemical resistance and high hardness of the resulting coatings.

This object has been achieved with the specific, sulphonate-group-modified polyisocyanates according to the invention.

### SUMMARY OF THE INVENTION

The present invention relates to binder compositions containing sulphonate-functional polyisocyanates and one or more polyorthoester and/or bicyclo orthoester groups which are either chemically incorporated into the sulphonate-functional polyisocyanates or present in admixture with the sulphonate-functional polyisocyanates.

The present invention also relates to a process for preparing the binder compositions of the invention by preparing
A) OH functional polyorthoesters by initially reacting
   A1) one or more acyclic orthoesters with
   A2) low molecular weight polyols having a functionality of 4 to 8 and a number average molecular weight of 80 to 500 g/mol and
   A3) optionally a 1,3 diol and/or a triol, wherein the hydroxyl groups are separated from one another by at least 3 carbon atoms, optionally in the presence of
   A4) catalysts,
and then reacting the resulting polyorthoesters either with
B) at least one sulphonate-functional polyisocyanate or
C) at least one sulphonate group-free polyisocyanate and subsequently mixing the resulting reaction mixture with at least one sulphonate-functional polyisocyanate.

The present invention also relates to a process for preparing the binder compositions of the invention by preparing
a) bicyclo orthoesters by initially reacting
   a1) one or more acyclic orthoesters with
   a2) low molecular weight polyols having an OH functionality of 3 or 4 and a number average molecular weight of 80 to 500 g/mol optionally in the presence of
   a3) catalysts,
and then reacting or mixing the resulting bicyclo orthoesters with
b) with at least one sulphonate-functional polyisocyanate or
c) at least one sulphonate group-free polyisocyanate and subsequently mixing the resulting reaction mixture with at least one sulphonate-functional polyisocyanate.

The present invention also relates to coating, adhesive and sealant compositions containing the binder compositions of the invention.

### DETAILED DESCRIPTION OF THE INVENTION

Polyorthoester groups are obtained when acyclic orthoesters are reacted with polyfunctional alcohols under transesterification conditions, the number of OH groups in the alcohol component being selected such that all of the ester groups in the acyclic orthoester undergo transesterification. The precise structure is primarily dependent on the functionality of the alcohols used and may be a cyclic structure or a spiral structure, among others. One particular case of a reaction product of this type are the bicyclo orthoester groups in which one molecule of acyclic orthoester is transesterified, with transesterification, with an at least trifunctional alcohol such as trimethylolpropane or pentaerythritol, always producing defined compounds or structures of the formula (I) 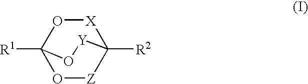
wherein the definition of variables X, Y, Z and R¹ and R² is dependent on the orthoester and polyfunctional alcohol employed. X and Z independently of one another are linear or branched alk(en)ylene groups having 1 to 4 carbon atoms and optionally containing an oxygen or a nitrogen atom. Y can have the same definition as X and Z or represents no structure. R¹ and R² are identical or different and correspond to monovalent radicals selected from hydrogen, hydroxyl groups and linear or branched alk(en)yl groups having 1 to 30 carbon atoms and optionally containing one or more heteroatoms.

Especially if the compositions of the invention contain polyorthoester groups they preferably have a number average molecular weight, Mₙ, of 500 to 3000 g/mol, more preferably 500 to 2200 g/mol.

In the case of the compounds containing bicyclo orthoester groups that are obtained according by reacting components a1) with a2) it is possible, depending on the OH functionality of compounds a2), to obtain both OH-free and OH-containing bicyclic orthoesters. This is then followed accordingly, in b) or c) respectively, by a reaction between free OH groups and NCO groups or merely by physical blending of the OH-free bicyclo orthoesters and the polyisocyanates. The particular alternative may be readily determined from the stoichiometry and OH functionality.

In addition to the route described above it is also possible to obtain OH-free bicyclic orthoesters by converting the corresponding ester-functional oxetane compounds using BF₃Et₂O, as described in EP-A 0 882 106, for example.

The sulphonate-functional polyisocyanates used in B) and b) or C) and c) preferably have an average isocyanate functionality of at least 1.8, an isocyanate group content (calculated as NCO; molecular weight=42) of 4.0% to 26.0% by weight, an incorporated sulphonic acid and sulphonate group content (calculated as SO₃⁻; molecular weight=80) of 0.1% to 7.7% by weight and an amount of incorporated ethylene oxide units attached within polyether chains (calculated as C₂H₂O; molecular weight=44) of 0 to 19.5% by weight, based on the corresponding polyether. If these polyisocyanates contain polyether chains, they preferably contain on average 5 to 35 ethylene oxide units.

The counterion to the sulphonate groups is preferably an ammonium ion formed from tertiary amines by protonation. The ratio of the sum of sulphonic acid groups and sulphonate groups to the sum of tertiary amine and the protonated ammonium ion derived therefrom is preferably 0.2 to 2.0.

Examples of the tertiary amines are monoamines such as trimethylamine, triethylamine, tripropylamine, tributylamine, dimethylcyclohexylamine, N-methylmorpholine, N-ethylmorpholine, N-methylpiperidine or N-ethylpiperidine; or tertiary diamines such as 1,3-bis(dimethylamino)propane, 1,4-bis(dimethylamino)butane or N,N′-dimethylpiperazine. Neutralizing amines which are also suitable, though less preferred, are tertiary amines that have isocyanate-reactive groups. Examples include alkanolamines such as dimethylethanolamine, methyldiethanolamine or triethanolamine. Preferred is dimethylcyclohexylamine.

The preparation of these modified polyisocyanates is described in detail in WO-A 01-88006. They are prepared from organic polyisocyanates preferably having an average NCO functionality of at least 2 and a molecular weight of at least 140 g/mol. Suitable examples include i) monomeric organic polyisocyanates having a molecular weight of 140 to 300 g/mol, ii) lacquer polyisocyanates having a number average molecular weight of 300 to 1000 g/mol, iii) NCO prepolymers containing urethane groups and having a number average molecular weight of more than 1000 g/mol, and mixtures thereof.

Examples of monomeric polyisocyanates i) include 1,4-diisocyanatobutane, 1,6-diisocyanato-hexane (HDI), 1,5-diisocyanato-2,2-dimethylpentane, 2,2,4- and/or 2,4,4-trimethyl-1,6-diisocyanatohexane, 1-isocyanato-3,3,5-trimethyl-5-isocyanatomethylcyclohexane (IPDI), 1-isocyanato-1-methyl-4-(3)-isocyanato-methylcyclohexane, bis(4-isocyanatocyclohexyl)methane, 1,10-diisocyanatodecane, 1,12-diisocyanatododecane, cyclohexane 1,3- and 1,4-diisocyanate, xylylene diisocyanate isomers, triisocyanatononane (TIN), 2,4-diisocyanatotoluene or mixtures with preferably up to 35% by weight of 2,6-diisocyanatotoluene, 2,2′-, 2,4′-, 4,4′-, diisocyanatodiphenylmethane, polyisocyanate mixtures of the diphenylmethane series, and mixtures thereof.

Polyisocyanates ii) are the known lacquer polyisocyanates. The lacquer polyisocyanates include compounds or mixtures of compounds which are obtained by known oligomerization reactions of monomeric diisocyanates i). Suitable oligomerization reactions include carbodiimidization, dimerization, trimerization, biuretization, urea formation, urethanization, allophanatization and/or cyclization with the formation of oxadiazinedione groups. In oligomerization reactions two or more of the reactions may run simultaneously or subsequent to one another.

The lacquer polyisocyanates ii) are preferably biuret polyisocyanates, polyisocyanates containing isocyanurate groups, polyisocyanate mixtures containing isocyanurate and uretdione groups, polyisocyanates containing urethane and/or allophanate groups, or polyisocyanate mixtures containing isocyanurate and allophanate groups.

The preparation of lacquer polyisocyanates is known and described, for example, in DE-A 1 595 273, DE-A 3 700 209 and DE-A 3 900 053 or in EP-A-0 330 966, EP-A 0 259 233, EP-A-0 377 177, EP-A-0 496 208, EP-A-0 524 501 or U.S. Pat. No. 4,385,171.

Polyisocyanates iii) are the known prepolymers that contain isocyanate groups and are prepared from monomeric diisocyanates i) and/or lacquer polyisocyanates ii) and organic polyhydroxyl compounds having a number average molecular weight of more than 300 g/mol. While lacquer polyisocyanates ii) that contain urethane groups are derivatives of low molecular weight polyols having a molecular weight of 62 to 300 g/mol (such as ethylene glycol, propylene glycol, trimethylolpropane, glycerol or mixtures of these alcohols), the polyhydroxyl compounds used to prepare the NCO prepolymers iii) have a number average molecular weight of more than 300 g/mol, preferably more than 500 g/mol and more preferably 500 to 8000 g/mol. These polyhydroxyl compounds have 2 to 6, preferably 2 to 3 hydroxyl groups per molecule and are selected from polyether, polyester, polythioether, polycarbonate, polyacrylate polyols and mixtures thereof.

During the preparation of NCO prepolymers iii) it is possible to use mixtures of the high molecular weight polyols and low molecular weight polyols such that mixtures of low molecular weight lacquer polyisocyanates ii), containing urethane groups, and higher molecular weight NCO prepolymers iii).

To prepare the NCO prepolymers iii) or their mixtures with lacquer polyisocyanates ii), diisocyanates i) and/or lacquer polyisocyanates ii) are reacted with the higher molecular weight hydroxyl compounds or mixtures thereof with low molecular weight polyhydroxyl compounds at an NCO/OH equivalent ratio of 1.1:1 to 40:1, preferably 2:1 to 25:1, to form urethane groups. When an excess of distillable starting diisocyanate is used it is possible to remove it by distillation subsequent to the reaction resulting in monomer-free NCO prepolymers.

To prepare the sulphonate-modified polyisocyanates the starting isocyanates are reacted optionally with difunctional polyethers, with partial urethanization of the NCO groups, and are then reacted with compounds which in addition to at least one sulphonic acid and/or sulphonate group also contain an isocyanate-reactive group, such as an OH or NH group. These compounds are preferably 2-(cyclohexylamino)ethanesulphonic acid and/or 3-(cyclohexylamino)propanesulphonic acid. Following the polymer synthesis, some or all of the sulphonic acid groups are deprotonated by addition of a base, preferably a tertiary amine.

With particular preference the polyisocyanates used as starting isocyanates are based on hexamethylene diisocyanate, isophorone diisocyanate and/or 4,4′-dicyclohexylmethane diisocyanate.

The sulphonate-group-free polyisocyanates used in C) or c) correspond to the starting isocyanates used for the preparation of the sulphonate-functional polyisocyanates.

Suitable components A1) or a1) include triethyl orthoformate, triisopropyl orthoformate, tripropyl orthoformate, trimethyl orthobutyrate, triethyl orthoacetate, trimethyl orthoacetate, triethyl orthopropionate or trimethyl orthovalerate. Preferred are triethyl orthoformate, triethyl orthoacetate, trimethyl orthoacetate and/or triethyl orthopropionate, more preferably triethyl orthoacetate and/or triethyl orthopropionate.

Suitable compounds A2) include pentaerythritol, ditrimethylolpropane, erythritol, diglyceride, dipentaerythritol, mannitol or methylglycoside. It is preferred to use pentaerythritol.

Polyols which can be used in a2) include glycerol, trimethylolpropane, 1,2,3-propanetriol, 1,2,4-butanetriol, 1,1,1-trimethylolethane, 1,2,6-hexanetriol, 1,1,1-trimethylolpropane and polyester-based triols having a number average molecular weight of 100 to 1000 g/mol. The latter can be prepared, for example, from the preceding triols by reaction with lactones, such as ε-caprolactone, β-propiolactone, γ-butyrolactone, γ- and δ-valerolactone, 3,5,5- and 3,3,5-trimethylcaprolactone and mixtures thereof. In a2) it is additionally possible to use pentaerythritol, ditrimethylolpropane, erythritol and diglyceride. Preferred are trimethylolpropane and pentaerythritol.

Examples of suitable diols for use as component A3) include neopentyl glycol, 2-methyl-1,3-propanediol, 2-methyl-2,4-pentanediol, 3-methyl-1,3-butanediol, 2-ethyl-1,3-hexanediol, 2,2-diethyl-1,3-propanediol, 2,2,4-trimethyl-1,3-pentanediol, 2-butyl-2-ethyl-1,3-propanediol, 2-phenoxypropane-1,3-diol, 2-methyl-2-phenylpropane-1,3-diol, 1,3-propylene glycol, 1,3-butylene glycol, dimethylolpropionic acid, dimethylolbutanoic acid, 2-ethyl-1,3-octanediol and 1,3-dihydroxycyclohexane; and fatty acid monoglyceride (β products) such as glyceryl monoacetate (β product) and glyceryl monostearate (β product). Preferred are neopentyl glycol, 2-methyl-1,3-propanediol, 2-methyl-2,4-pentanediol, 3-methyl-1,3-butanediol, 2-ethyl-1,3-hexanediol, 2,2-diethyl-1,3-propanediol, 2,2,4-trimethyl-1,3-pentanediol and 2-butyl-2-ethyl-1,3-propanediol.

Examples of triols of component A3) are 1,2,3-propanetriol, 1,2,4-butanetriol, 1,1,1-trimethylolethane, 1,2,6-hexanetriol, 1,1,1-trimethylolpropane and polyester-based triols having a number average molecular weight of 100 to 1000 g/mol. The latter can be prepared, for example, from the preceding triols by reaction with lactones such as ε-caprolactone, β-propiolactone, γ-butyrolactone, γ- and δ-valerolactone, 3,5,5- and 3,3,5-trimethylcaprolactone and mixtures thereof. A preferred triol for use as component A3) is trimethylolpropane.

The equivalent ratio of groups to be transesterified in the compounds of component A1) to the OH groups of the compounds of components A2) and optionally A3) is preferably 1:1.1 to 1:1.7 more preferably 1:1.3 to 1:1.5. In order to achieve adequate hardness in the coating, the equivalent ratio of OH groups from A2) to those from A3) is preferably 1:0 to 1:7, more preferably 1:0 to 1:4.

The equivalent ratio of groups to be transesterified in the compounds of component a1) to the OH groups of the compounds of components a2) is preferably 1:1 to 1:1.7, more preferably 1:1 to 1:1.5.

As catalysts A4) or a3) for the transesterification reaction it is possible to use the known esterification catalysts, such as acids, bases or transition metal compounds. Lewis or Broenstedt acids are preferred; p-toluenesulphonic acid is particularly preferred. The catalysts are used in the process of the invention in amounts of 0.001% to 5% by weight, preferably 0.01% to 1% by weight, based on the sum of the amounts of components A1)-A3) or a1) and a2), respectively.

The reaction temperature of the transesterification reaction is 50 to 200° C., preferably 75 to 150° C. In one preferred embodiment of the invention the alcohol eliminated during the transesterification is removed by distillation from the reaction mixture, optionally employing vacuum. In this way not only the shift in equilibrium but also the end of the transesterification reaction is readily apparent, since it is over as soon as elimination product (alcohol) no longer distils over.

The equivalent ratio of NCO-reactive groups of the polyorthoester and/or bicyclo orthoester from the transesterification reaction to NCO groups of the sulphonate-functional polyisocyanate in B) or b) or the sulphonate-free polyisocyanate from C) or c) is preferably 1:1 to 1:40, more preferably 1:1 to 1:10, very preferably 1:1 to 1:3.2. The reaction of the isocyanate-reactive polyorthoester and/or bicyclo orthoester with the polyisocyanates takes place preferably at temperatures of 60 to 150° C., preferably 80 to 130° C.

If necessary it is possible in step B) or b) to use the known catalysts from polyurethane chemistry for accelerating the NCO/OH reaction. Examples of these catalysts include organometallic compounds, amines (e.g. tertiary amines) or metal compounds such as lead octoate, mercury succinate, tin octoate or dibutyltin dilaurate. If these catalysts are used they are employed preferably in amounts of 0.001% to 5% by weight, more preferably 0.002% to 2% by weight of catalyst, based on the total amount of polyorthoester and polyisocyanate.

Both the transesterification and the reaction or mixture preparation of isocyanate-reactive polyorthoester and bicyclo orthoester with the polyisocyanate can take place in the presence of solvents and/or additives.

Examples of suitable solvents include esters such as ethyl acetate, butyl acetate, methoxypropyl acetate, methyl glycol acetate, ethylglycol acetate or diethylene glycol monomethyl ether acetate; ketones such as methyl ethyl ketone, methyl isobutyl ketone or methyl amyl ketone; aromatic solvents such as toluene and xylene; and the known, relatively high-boiling hydrocarbon mixtures from coating technology. Adjustments to viscosity can also take place, if desired, by the addition of these solvents.

Examples of suitable additives include surface-active substances, internal release agents, fillers, dyes, pigments, flame retardants, hydrolysis stabilizers, microbicides, flow control aids and antioxidants such as 2,6-di-tert-butyl-4-methylphenol, UV absorbers of the 2-hydroxyphenylbenzotriazole type, and light stabilizers such as the HALS compounds unsubstituted or substituted on the nitrogen atom, e.g., Tinuvin® 292 and Tinuvin® 770 DF (Ciba Spezialitäten GmbH, Lampertheim, Del.) or other commercially available stabilizers, as described for example in “Lichtschutzmittel für Lacke” (A. Valet, Vincentz Verlag, Hannover, 1996 and “Stabilization of Polymeric Materials” (H. Zweifel, Springer Verlag, Berlin, 1997, Appendix 3, pp. 181-213), or mixtures of these compounds.

Any residual di- and/or triisocyanate monomers that are still present after the reaction of polyorthoester with polyisocyanate can be removed if desired by distillation, such that the polymers of the invention contain residual di- and/or triisocyanate monomer contents of preferably <0.5% by weight.

The coating, adhesive and sealant compositions may additionally contain catalysts, polyisocyanates and/or additives. Additional polyisocyanates include those previously set forth as starting isocyanates for preparing the binder compositions of the invention. Suitable additives include those previously set forth.

Suitable catalysts include the known urethanization catalysts. Examples include tertiary amines such as triethylamine, pyridine, methylpyridine, benzyldimethylamine, N,N-endoethylenepiperazine, N-methylpiperidine, pentamethyldiethylenetriamine, N,N-dimethylaminocyclohexane and N,N′-dimethylpiperazinep; metal salts such as iron(III) chloride, zinc chloride, zinc 2-ethylcaproate, tin(II) octoate, tin(II) ethylcaproate, tin(II) palmitate, dibutyltin(IV) dilaurate and molybdenum glycolate; mixtures thereof.

The catalyst is used preferably in amounts, based on the total weight of the binder compositions of the invention and optionally additional polyisocyanate, of 0.001% to 5% by weight, preferably 0.01% to 1% by weight.

The equivalent ratio of latent OH groups to free isocyanate groups in the curable compositions of the invention is preferably 0.5:1 to 2.0:1, more preferably 0.8:1 to 1.5:1 and most preferably 1:1.

The curable compositions of the invention can be applied to any desired substrates by known methods, such as spraying, brushing, flow coating or by rolls or knife coaters. Examples of suitable substrates include metal, wood, glass, stone, ceramic materials, concrete, plastics both rigid and flexible, textiles, leather or paper.

The invention is further illustrated but is not intended to be limited by the following examples in which all parts and percentages are by weight unless otherwise specified.

### EXAMPLES

Unless indicated otherwise, all percentages are to be understood as referring to percent by weight.

The dynamic viscosities were determined at 23° C. using a rotational viscometer (Visco Tester® 550, Thermo Haake GmbH, D-76227 Karlsruhe).

The solids content was determined in accordance with DIN EN ISO 3251 (1 g sample, 1-hour drying time in a forced-air oven at 125° C.).

As a measure of the pot life the flow time was determined in accordance with DIN 53211.

The drying rate was determined in accordance with DIN 53157, DIN EN ISO 1517.

The Konig pendulum hardness was determined in accordance With DIN 53157 (after drying at 60° C. for 10 minutes and subsequent storage at room temperature for 7 days).

The petrol resistance of the coatings was determined by placing a cotton-wool pad, soaked with commercially customary super-grade petrol, on the coating for 1 or 5 minutes. After this time the coating was wiped dry with a cloth and assessed optically in a grading from 0 to 5. (0: No change; 5: severe swelling). The measurements obtained after drying at 60° C. for 10 minutes and subsequent storage at room temperature for 7 days are set forth in the tables below.

Starting Materials:

MPA: methoxypropyl acetate

DBTL: dibutyltin dilaurate

IPDI: isophorone diisocyanate

Byk® 331 and 141: flow control aids from Byk Chemie, Wesel, Del.

Polyisocyanate 1: Desmodur® N3600, HDI trimer having an NCO content of 23.0% and a viscosity at 23° C. of 1200 mPa·s, Bayer MaterialScience AG, Leverkusen, Del.

Polyisocyanate 2: Desmodur® XP 2570, sulphonate-functional aliphatic polyisocyanate based on HDI having an NCO content of 20.6% and a viscosity at 23° C. of 3500 mPa·s, Bayer MaterialScience AG, Leverkusen, Del.

Polyisocyanate 3: Desmodur® XP 2487/1, sulphonate-functional aliphatic polyisocyanate based on HDI having an NCO content of 20.9% and a viscosity at 23° C. of 6900 mPa·s, Bayer MaterialScience AG, Leverkusen, Del.

Polyisocyanate 4: Desmodur® XP 2547, sulphonate-functional aliphatic polyisocyanate based on HDI having an NCO content of 23% and a viscosity of 600 mPa·s, Bayer MaterialScience AG, Leverkusen, Del.

Polyisocyanate 5: Desmodur® XP 2410, asymmetric HDI trimer having an NCO content of 23.7% and a viscosity at 23° C. of 700 mPa·s, Bayer MaterialScience AG, Leverkusen, Del.

Polyisocyanate 6: 1:1 mixture of polyisocyanate 4 and polyisocyanate 5

Polyisocyanate 7: Desmodur® N3200, HDI biuret having an NCO content of 23.0% and a viscosity at 23° C. of 2500 mPa·s, Bayer MaterialScience AG, Leverkusen, Del.

Polyisocyanate 8: Desmodur® N3390, HDI trimer, 90% in butyl acetate, having an NCO content of 19.6% and a viscosity at 23° C. of 650 mPa-s, Bayer MaterialScience AG, Leverkusen, Del.

### Example 1

### Preparation of a Polyorthoester

162 g of triethylene orthoacetate, 102 g of pentaerythritol and 80 g of 2-butyl-2-ethyl-1,3-propanediol were weighed out together into a reactor, which was equipped with stirrer, heating, automatic temperature control, nitrogen inlet and distillation column, and were heated to 85° C., with stirring and while nitrogen was passed through. The temperature was slowly raised to 120° C.; ethanol was removed by distillation. After 6 hours the distillation of ethanol was at an end and a vacuum of 500 mbar at 120° C. was applied in order to distil off the remaining ethanol. Subsequently 180 g of butyl acetate were added. Then at 120° C. 83.25 g of IPDI were added dropwise and the reaction was continued at 120° C. until the NCO band at 2280 cm⁻¹ in the IR disappeared. Thereafter, 45.75 g of polyisocyanate 1 were added dropwise at 120° C. and stirring was continued until the theoretical NCO content was reached.

### Example 2

### Preparation of a Bicyclic Orthoester

704 g of triethylene orthopropionate, 536 g of trimethylolpropane and 1.2 g of para-toluenesulphonic acid were weighed out together into a reactor, which was equipped with stirrer, heating, automatic temperature control, nitrogen inlet and distillation column, and were heated to 85° C., with stirring and while nitrogen was passed through. The temperature was slowly raised to 120° C.; ethanol was removed by distillation. After 6 hours the distillation of ethanol was at an end and a vacuum of 500 mbar at 120° C. was applied in order to distil off the remaining ethanol. To purify the bicyclic orthoester the crude product was subjected to fractional distillation under vacuum (10 mbar). At an overhead temperature of 87 to 92° C. a total of 558 g (yield 84%) of the pure compound were obtained. The product had a low viscosity and a latent OH content of 19.8% by weight.

Varnish Preparation

The polymer from Example 1 and the bicyclic orthoester from Example 2 were each formulated as per Table 1 with commercially available coating additives, catalyst (component A) and sulphonate-functional polyisocyanates (component B) as a two-component system, with stirring, and then applied to glass, using a 150 μm knife coater, and cured at 60° C. for 10 minutes.

For the comparative examples (Table 2) the polymer from Example 1 or the bicyclic orthoester from Example 2 was admixed with commercially available coating additives, catalysts (component A), dodecylbenzenesulphonic acid (component B) and sulphonate group-free polyisocyanates (component C) as a three-component system, with stirring, and then applied to glass using a 150 μm knife coater and cured at 60° C. for 10 minutes.

TABLE 1
Coating composition and performance data (amounts in parts by weight)

| | Example | | | | | | | |
|---|---|---|---|---|---|---|---|---|
| | 3 | 4 | 5 | 6 | 7 | 8 | 9 | 10 |
| Component A: | | | | | | | | |
| Product from | 39.86 | 41.27 | 44.40 | 42.06 | | | | |
| Example 1 | | | | | | | | |
| Product from | | | | | 21.82 | 22.03 | 22.06 | 22.88 |
| Example 2 | | | | | | | | |
| Byk ® 331 | 0.11 | 0.12 | 0.12 | 0.11 | 0.15 | 0.15 | 0.14 | 0.15 |
| Byk ® 141 | 0.72 | 0.74 | 0.76 | 0.73 | 0.92 | 0.92 | 0.87 | 0.92 |
| DBTL 10% in | 1.15 | 1.19 | 1.22 | 1.17 | 1.47 | 1.47 | 1.39 | 1.47 |
| xylene | | | | | | | | |
| MPA/xylene/BA | 26.62 | 24.50 | 21.61 | 24.97 | 23.86 | 23.89 | 23.93 | 24.07 |
| 1:1:1 | | | | | | | | |
| Component B: | | | | | | | | |
| Polyisocyanate 1 | | | | | | | | |
| Polyisocyanate 2 | 31.54 | | | | 51.79 | | | |
| Polyisocyanate 3 | | 32.19 | | | | 51.54 | | |
| Polyisocyanate 4 | | | 31.89 | | | | 51.61 | |
| Polyisocyanate 5 | | | | | | | | |
| Polyisocyanate 6 | | | | 30.96 | | | | 50.52 |
| Dodecylbenzenesulphonic | | | | | | | | |
| acid | | | | | | | | |
| Solids | 57.7 | 59.2 | 61.0 | 58.5 | 73.9 | 73.8 | 73.9 | 73.7 |
| Flow time DIN4 | | | | | | | | |
| (sec) after | | | | | | | | |
| 0.0 h | 20 | 23 | 22 | 21 | 16 | 15 | 15 | 15 |
| 1.0 | 24 | 31 | 26 | 24 | 16 | 16 | 14 | 14 |
| 2.0 | 24 | 33 | 28 | 25 | 16 | 16 | 14 | 14 |
| 3.0 | 25 | 32 | 28 | 25 | 16 | 16 | 14 | 14 |
| 4.0 | 25 | 33 | 28 | 25 | 17 | 16 | 14 | 14 |
| Drying time 10 min | 0/0 | 0/0 | 0/0 | 0/0 | | | | |
| 60° C. | | | | | | | | |
| T1 + min | 0 | 0 | 0 | 0 | 60 | 60 | 180 | 120 |
| T3 + h | 0 | 0.3 | 0.4 | 0.3 | 5.0 | 5.0 | >7.0 | >7.0 |
| T4 + h | 2.0 | 2.0 | 3.5 | 3.5 | 7.0 | 7.0 | — | — |
| Film optical | clear | clear | clear | clear | clear | clear | clear | clear |
| quality | | | | | | | | |
| Pendulum | 114 | 109 | 145 | 132 | 125 | 192 | 199 | 155 |
| hardness | | | | | | | | |
| Petrol resistance | 0/1 | 0/0 | 0/0 | 0/0 | 0/0 | 0/0 | 0/0 | 0/0 |
| 1 min/5 min | | | | | | | | |

0 = no change,
5 = severe swelling

TABLE 2
Coating composition and performance data of the comparative examples (amounts
in parts by weight)

| | Example | | | | | |
|---|---|---|---|---|---|---|
| | 11 | 12 | 13 | 14 | 15 | 16 |
| Component A: | | | | | | |
| Product from Example 1 | 45.13 | 42.83 | 41.25 | | | |
| Product from Example 2 | | | | 23.61 | 23.17 | 21.19 |
| | | | | 0.14 | 0.15 | 0.14 |
| Byk ® 141 | 0.75 | 0.73 | 0.72 | 0.90 | 0.91 | 0.86 |
| DBTL 10% in xylene | 1.21 | 1.17 | 1.16 | 1.45 | 1.46 | 1.38 |
| MPA/xylene/BA 1:1:1 | 19.5 | 22.67 | 20.38 | 23.99 | 23.9 | 22.5 |
| Component B: | | | | | | |
| Polyisocyanate 4 | | | | | | |
| Polyisocyanate 5 | 31.04 | | | 48.72 | | |
| Polyisocyanate 6 | | | | | | |
| Polyisocyanate 7 | | 30.35 | | | 49.26 | |
| Polyisocyanate 8 | | | 34.31 | | | 52.88 |
| Component C: | | | | | | |
| Dodecylbenzenesulphonic acid | 2.26 | 2.14 | 2.06 | 1.18 | 1.16 | 1.06 |
| 10% in xylene | | | | | | |
| Solids | 60.8 | 58.6 | 58.1 | 72.7 | 72.8 | 69.1 |
| Flow time DIN4 (sec) after | | | | | | |
| 0.0 h | 21 | 22 | 21 | 15 | 18 | 15 |
| 1.0 | 25 | 34 | 28 | 14 | 18 | 15 |
| 2.0 | 26 | 35 | 29 | 14 | 18 | 14 |
| 3.0 | 27 | 35 | 30 | 14 | 18 | 14 |
| 4.0 | 28 | 35 | 32 | 14 | 18 | 14 |
| Drying time 10 min 60° C. | 0/0 | 0/0 | 0/0 | | | |
| T1 + min | 0 | 0 | 0 | 0 | 0 | 0 |
| T3 + h | 0 | 0.3 | 1.0 | 0 | 0 | 0 |
| T4 + h | 0 | 2.5 | 4.0 | 1.0 | 1.0 | 1.0 |
| Film optical quality | cloudy | cloudy | cloudy | cloudy | cloudy | cloudy |
| Pendulum hardness | 99 | 76 | 120 | 13 | 11 | 11 |
| Petrol resistance | 0/0 | 0/1 | 0/0 | 0/0 | 1/1 | 0/0 |
| 1 min/5 min | | | | | | |

0 = no change,
5 = severe swelling

The coatings prepared from the binder compositions of the invention from Table 1 can be applied as a two-component system and demonstrated rapid cure, good chemical resistance, high ultimate hardness and outstanding film optical quality. Their properties are better than or at least comparable with those of the comparison examples from Table 2, which were applied as a three component system. The compositions of the comparison examples do not cure markedly without the addition of dodecylbenzenesulphonic acid.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A binder composition comprising a sulphonate-functional polyisocyanate and one or more polyorthoester and/or bicyclo orthoester groups which are either chemically incorporated into the sulphonate-functional polyisocyanate or present in admixture with the sulphonate-functional polyisocyanate.

2. The binder composition of claim 1 wherein the one or more polyorthoester and/or bicyclo orthoester groups are chemically incorporated into the sulphonate-functional polyisocyanate.

3. The binder composition of claim 1 wherein the sulphonate-functional polyisocyanate is prepared from hexamethylene diisocyanate, isophorone diisocyanate and/or 4,4′-dicyclohexylmethane diisocyanate.

4. The binder composition of claim 2 wherein the sulphonate-functional polyisocyanate is prepared from hexamethylene diisocyanate, isophorone diisocyanate and/or 4,4′-dicyclohexylmethane diisocyanate.

5. The binder composition of claim 1 wherein the sulphonate-functional polyisocyanate comprises the reaction product of a polyisocyanate prepared from hexamethylene diisocyanate, isophorone diisocyanate and/or 4,4′-dicyclohexylmethane diisocyanate with 2-(cyclohexylamino)ethanesulphonic acid and/or 3-(cyclohexylamino)propanesulphonic acid.

6. The binder composition of claim 2 wherein the sulphonate-functional polyisocyanate comprises the reaction product of a polyisocyanate prepared from hexamethylene diisocyanate, isophorone diisocyanate and/or 4,4′-dicyclohexylmethane diisocyanate with 2-(cyclohexylamino)ethanesulphonic acid and/or 3-(cyclohexylamino)propanesulphonic acid.

7. A process for preparing a binder composition comprising a sulphonate-functional polyisocyanate and one or more polyorthoester and/or bicyclo orthoester groups which are either chemically incorporated into the sulphonate-functional polyisocyanate or present in admixture with the sulphonate-functional polyisocyanate which comprises preparing
A) an OH functional polyorthoester by initially reacting
A1) one or more acyclic orthoesters with
A2) a low molecular weight polyol having a functionality of 4 to 8 and a number average molecular weight of 80 to 500 g/mol and
A3) optionally a 1,3 diol and/or a triol, wherein the hydroxyl groups are separated from one another by at least 3 carbon atoms,
optionally in the presence of
A4) a catalyst,
and then reacting the resulting polyorthoester with
B) at least one sulphonate-functional polyisocyanate or
C) at least one sulphonate group-free polyisocyanate and subsequently mixing the resultant reaction mixture with at least one sulphonate-functional polyisocyanate.

8. The process of claim 7 wherein the equivalent ratio of groups to be transesterified in component A1) to the OH groups of components A2) and A3) is 1:1.3 to 1:1.5 and the equivalent ratio of OH groups from component A2) to component A3) is 1:0 to 1:4.

9. The process of claim 7 wherein the sulphonate-functional or sulphonate group-free polyisocyanates are prepared from hexamethylene diisocyanate, isophorone diisocyanate and/or 4,4′-dicyclohexylmethane diisocyanate.

10. The process of claim 8 wherein the sulphonate-functional or sulphonate group-free polyisocyanates are prepared from hexamethylene diisocyanate, isophorone diisocyanate and/or 4,4′-dicyclohexylmethane diisocyanate.

11. The process of claim 7 wherein the sulphonate-functional polyisocyanate in components B) and/or C) comprises the reaction product of a polyisocyanate prepared from hexamethylene diisocyanate, isophorone diisocyanate and/or 4,4′-dicyclohexylmethane diisocyanate with 2-(cyclo-hexylamino)ethanesulphonic acid and/or 3-(cyclohexylamino)propanesulphonic acid.

12. The process of claim 8 wherein the sulphonate-functional polyisocyanate in components B) and/or C) comprises the reaction product of a polyisocyanate prepared from hexamethylene diisocyanate, isophorone diisocyanate and/or 4,4′-dicyclohexylmethane diisocyanate with 2-(cyclo-hexylamino)ethanesulphonic acid and/or 3-(cyclohexylamino)propanesulphonic acid.

13. A process for preparing a binder composition comprising a sulphonate-functional polyisocyanate and one or more polyorthoester and/or bicyclo orthoester groups which are either chemically incorporated into the sulphonate-functional polyisocyanate or present in admixture with the sulphonate-functional polyisocyanate which comprises preparing
a) bicyclo orthoester by initially reacting
a1) one or more acyclic orthoesters with
a2) a low molecular weight polyol having an OH functionality of 3 or 4 and a number average molecular weight of 80 to 500 g/mol
optionally in the presence of
a3) a catalyst
and then reacting or mixing the resulting bicyclo orthoester with
b) at least one sulphonate-functional polyisocyanate or
c) at least one sulphonate group-free polyisocyanate and subsequently mixing the resulting reaction mixture with at least one sulphonate-functional polyisocyanate.

14. The process of claim 13 wherein the equivalent ratio of groups to be transesterified in component a1) to the OH groups of component a2) is 1:1 to 1:1.5.

15. The process of claim 13 wherein the sulphonate-functional and sulphonate group-free polyisocyanates are prepared from hexamethylene diisocyanate, isophorone diisocyanate and/or 4,4′-dicyclohexylmethane diisocyanate.

16. The process of claim 14 wherein the sulphonate-functional and sulphonate group-free polyisocyanates are prepared from hexamethylene diisocyanate, isophorone diisocyanate and/or 4,4′-dicyclohexylmethane diisocyanate.

17. The process of claim 13 wherein the sulphonate-functional polyisocyanate in components b) and/or c) comprises the reaction product of a polyisocyanate prepared from hexamethylene diisocyanate; isophorone diisocyanate and/or 4,4′-dicyclohexylmethane diisocyanate with 2-(cyclo-hexylamino)ethanesulphonic acid and/or 3-(cyclohexylamino)propanesulphonic acid.

18. The process of claim 14 wherein the sulphonate-functional polyisocyanate in components b) and/or c) comprises the reaction product of a polyisocyanate prepared from hexamethylene diisocyanate, isophorone diisocyanate and/or 4,4′-dicyclohexylmethane diisocyanate with 2-(cyclo-hexylamino)ethanesulphonic acid and/or 3-(cyclohexylamino)propanesulphonic acid.

19. A coating, adhesive or sealant composition comprising the binder composition of claim 1.

20. A substrate coated with the coating composition of claim 19.
